(19) United States
(12) Patent Application Publication
(10) Pub. No.: US 2009/0270076 A1
(43) Pub. Date: Oct. 29, 2009

(54) PERFORMANCE OPTIMIZER FOR MOBILE DEVICES WEBSITE

(75) Inventors: Dennis Zhou, Shanghai (CN); Culbertson Zhao, Shanghai (CN); Sicheng Zhang, Shanghai (CN); Goden Yao, Shanghai (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/111,197

(22) Filed: Apr. 29, 2008

(51) Int. Cl. H04M 3/42

(52) U.S. Cl. 455/414.1

(57) ABSTRACT

A method for creating a response to a hypertext transfer protocol (HTTP) request from a mobile device. The HTTP request is received from the mobile device. A determination may be made as to whether to optimize the response based on the HTTP request. If it is determined that the response is to be optimized, then an action to be performed on an object in connection with optimizing the response is determined. The object may be part of a document specified in the HTTP request. An optimized response may then be generated based on the action.

### BACKGROUND

Accessing the Internet from a mobile device, such as a phone or a personal digital assistant (PDA), may involve certain considerations. Because the typical mobile devices are smaller than the typical desktop computer, the resources available to the mobile device are lesser in comparison. Mobile devices generally have smaller memories, displays, and less powerful processors than a desktop computer. Because of the limited resources, mobile devices may access Internet sites specifically designed for reduced resource devices, such as mobile phones. The wireless application protocol (WAP) and i-mode are two approaches for providing access to these sites for mobile devices.

WAP is an open international standard for software applications that use wireless communications. Mobile devices may include WAP browsers that may be configured to access WAP Internet sites. The WAP browser provides all of the basic services of a computer-based web browser but is simplified to operate within the restrictions of a mobile device, such as a smaller view screen. WAP browsers typically interface with WAP Internet sites, which may be written in, or dynamically converted to, WML (Wireless Markup Language).

I-mode is a wireless Internet service that enables mobile phone users to access Internet sites customized for presentations on mobile devices. With i-mode, a mobile device may access these Internet sites that are designed specifically for presentations on mobile devices. These Internet sites may be written in compact hypertext markup language (C-HTML).

### SUMMARY

Described herein are implementations of various technologies for creating a response to a hypertext transfer protocol (HTTP) request from a mobile device. In one implementation, the HTTP request may be received by the wireless application protocol (WAP) server. In response, the WAP server may determine as to whether to optimize the response based on the HTTP request. If it is determined that the response is to be optimized, then the WAP server may determine an action to be performed on an object in connection with optimizing the response. The object may be part of a document specified in the HTTP request. The WAP server may then generate an optimized response based on the action.

The object within the web page may include an image object, video object, audio object, or combinations thereof. The action may include removing the object from the web page, or replacing the object with a substitute object. The substitute object may be configured to use fewer resources to be displayed on the mobile device than the actual object. In one implementation, the substitute object may be a text description of the object.

The determination to optimize the response may be based on a user preference for reducing response times to the mobile device, capabilities of the mobile device, and/or capabilities of a carrier network for the mobile device.

The user preference for reducing response times to the mobile device may be stored on a web server for mobile devices in response to a user selection on the mobile device. In one implementation, a user interface may display a hyperlink that specifies a user preference to reduce a response time to the HTTP request from the mobile device. In response to receiving a user selection of the hyperlink, the user preference may be sent to the web server for mobile devices.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic diagram of a computing system in which the various technologies described herein may be incorporated and practiced.

FIG. 2A illustrates a data flow diagram of a method in accordance with one or more implementations of various techniques described herein.

FIG. 2B illustrates a flowchart of a process in accordance with one or more implementations of various techniques described herein.

FIG. 3 illustrates a data flow diagram of a process in accordance with one or more implementations of various techniques described herein.

FIG. 4 illustrates a flowchart of a method in accordance with one or more implementations of various techniques described herein.

### DETAILED DESCRIPTION

In general, one or more implementations of various technologies described herein are directed to optimizing the delivery of wireless application protocol content to a mobile device. In one implementation, a wireless application protocol (WAP) server receives a hypertext transfer protocol (HTTP) request from a mobile device. Typically, the HTTP request identifies a web page that is to be presented on the mobile device. Identifiers for the mobile device, browser software, and a carrier network for the mobile device may be extracted from the HTTP request.

If a user preference for reducing response times to the device is stored on the WAP server, the response to the mobile device may include an abbreviated version of the requested web page, whereby media within the web page may be removed or replaced with substitute objects. The substitute objects may use fewer resources to be presented on the mobile device than the replaced media.

If a user preference for reducing response times to the device is not stored on the WAP server, the response may still include the abbreviated version of the requested web page. The decision whether to send the abbreviated version may be based on performance characteristics of the mobile device, the browser software, and/or the carrier network. The performance characteristics may be derived based on the identifiers extracted from the HTTP request.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

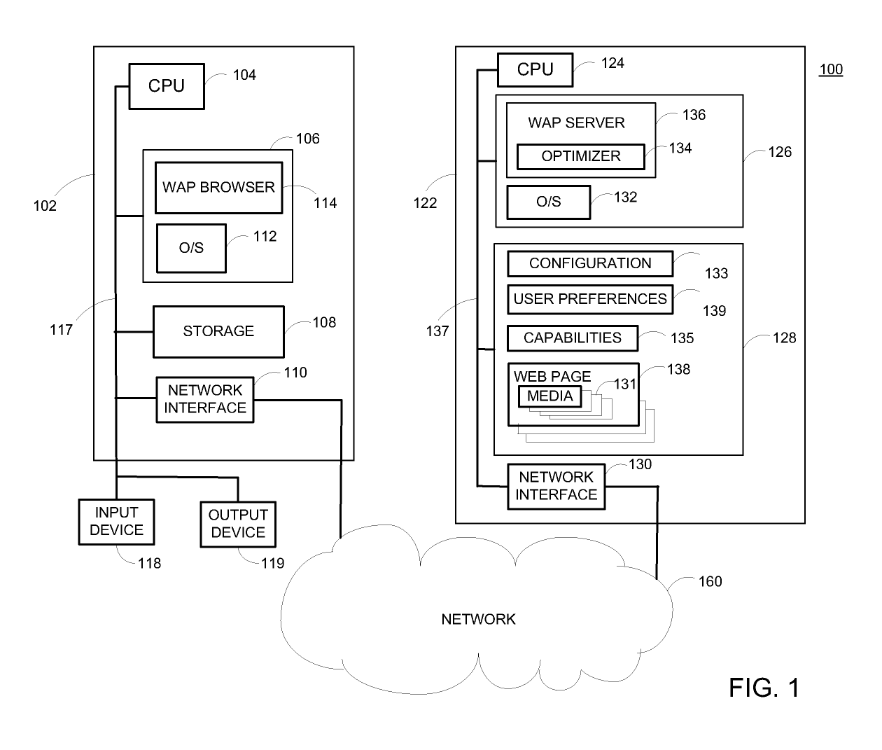

FIG. 1 illustrates a schematic diagram of a computing system 100 in which the various technologies described herein may be incorporated and practiced. The computing system 100 may include a client 102 and a server 122 remotely connected via a network 160. The client 102 may be a mobile device, such as a cellular phone or a personal digital assistant (PDA). The server 122 may be a computer that provides web content in response to requests from the client 102. Although the server 122 may be a conventional desktop or server computer, as described above, other computer system configurations may be used.

The client 102 may be connected to the network 160 through a network interface 110. Similarly, the server 122 may be connected to the network 160 through a network interface 130. In one implementation, the network interface 110, and the network interface 130 are network interface cards.

The network 160 may be any network or collection of networks that link remote computers such as a local area network or a wide area network. In one implementation, the network 160 is the Internet and a carrier network. In such an implementation, the carrier network connects the client 102 to the Internet.

The client 102 may include a central processing unit (CPU) 104 and a system bus 117 that couples various system components including system memory 106 to the CPU 104. Although only one CPU 104 is illustrated in FIG. 1, it should be understood that in some implementations the client 102 may include more than one CPU. The system bus 117 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The client 102 may further include a storage 108, which may be connected to the bus 117. Examples of storage 108 include a hard disk drive for reading from and writing to a hard disk, a magnetic disk drive for reading from and writing to a removable magnetic disk, and an optical disk drive for reading from and writing to a removable optical disk, such as a CD-ROM or other optical media. The storage 108 and associated computer-readable media may provide nonvolatile storage of computer-readable instructions, data structures, program modules and other data for the client 102.

It should be appreciated by those skilled in the art that the client 102 may also include other types of storage 108 and associated computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the client 102. Communication media may embody computer-readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

A number of program modules may be stored in the system memory 106, including an operating system 112, and a wireless application protocol (WAP) browser 114. The operating system 112 may be any suitable operating system that may control the operation of a mobile device, such as Windows® Mobile, Palm® OS, and the like. The WAP browser 114 may be a web browser designed for use on a mobile device such as a mobile phone or PDA. It should be noted that the WAP browser 114 is used merely as one example of presentation software for the client 102. Other software designed to effectively present web content on the small screens typical of most mobile devices may be used in implementations described herein.

A user may enter commands and information into the client 102 through an input device 118. Examples of input devices 118 include keyboards, pointing devices, microphones, joysticks, touch pads, touch screens, or the like. These and other input devices may be connected to the CPU 104 through the system bus 117. A user may receive information from the client 102 via an output device 119. Examples of output devices 119 include displays and speakers.

The server 122 may be similarly constructed as the client 102. The server 122 may contain a CPU 124, system memory 126, storage 128, and network interface 130 interconnected by a bus 137. The system memory 126 may include an operating system 132 and a WAP server 136. The WAP server 136 may be software that receives hypertext transfer protocol (HTTP) requests for a web page from the WAP browser 114. Additionally, the WAP server may send a response to the client 102 that includes the web page 138, which may be presented on the client 102.

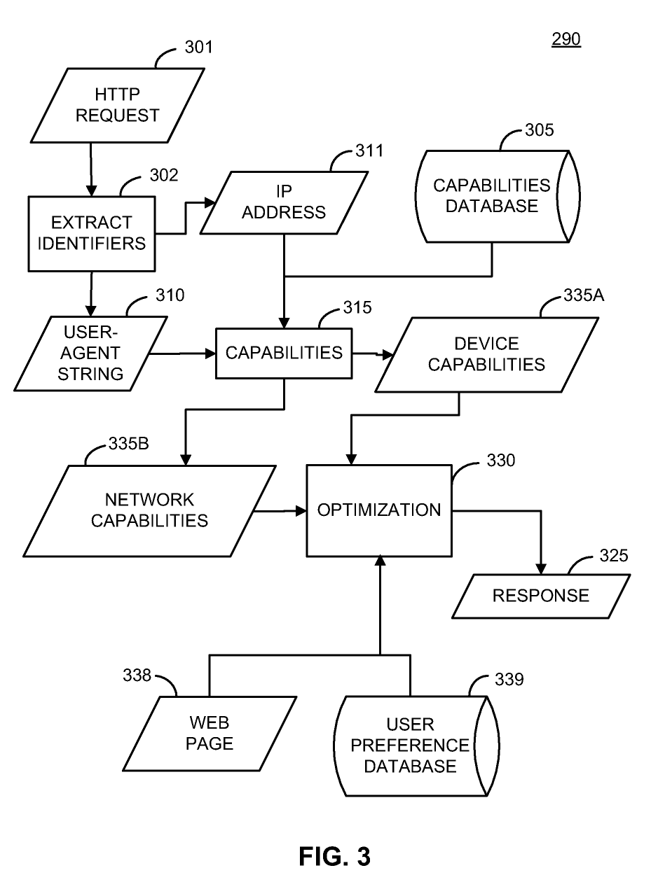

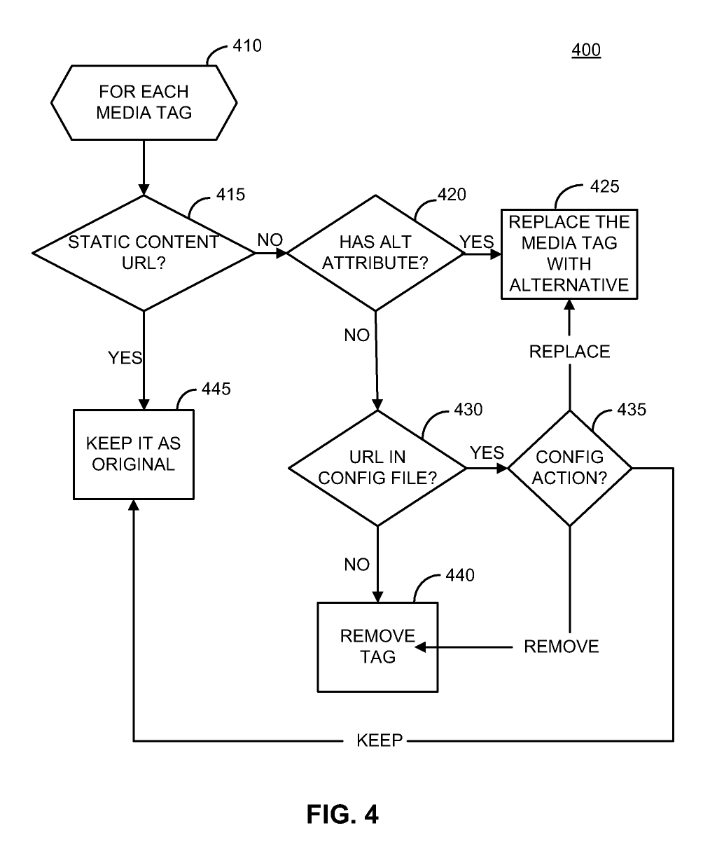

In one implementation, the WAP server 136 may also include an optimizer 134. The optimizer 134 may be software that intelligently modifies the web page 138 included in the response. The modifications may reduce the resources used for presenting the web page 138 to the user (optimization). The optimizer 134 will be described in greater detail in the descriptions of FIGS. 3-4.

The storage 128 may include the web pages 138, configuration 133, capabilities 135, and user preferences 139. The web pages 138 may be content written in wireless markup language (WML), extensible hypertext markup language (XHTML), compact HTML (C-HTML), or the like. Additionally, the web pages 138 may include media 131. The media 131 may be content such as images, audio, video, or any other resource-intensive content. Typically, the web page 138 may include a link to the media 131, whereby the WAP server 136 may retrieve the media 131 using a uniform resource locator (URL) in the link. In one implementation, the media 131 may be stored on another server 122 (not shown).

It should be noted that the web page 138 is provided merely as one example of a document that may be returned in response to an HTTP request. Any document written specifically for presentation on a reduced resource device, such as the client 102, may be used. Such documents include documents written in C-HTML, WML, XHTML, or the like.

The configuration 133 may specify actions that may be performed by the optimizer 134 (in response to the HTTP request) when the web page 138 includes media 131. In one implementation, the actions may include leaving the media 131 in the web page 138, removing the media 131, or replacing the media 131. The media 131 may be replaced with content that can be presented on the client 102 using fewer resources than would be used to present the media 131. In one implementation, the media 131 may be replaced with text. Advantageously, by removing the media 131, or replacing the media 131 with content requiring fewer resources, the client 102 may present the web page 138 to the user more quickly than the web page 138 would be presented with the original media 131.

The capabilities 135 may specify performance characteristics of the WAP browser 114, the client 102 and the network 160. In one implementation, the optimizer 134 may use the capabilities 135 to determine whether to optimize the response to the HTTP request. For example, performance characteristics of the client 102 may include a maximum web page size, which may determine whether the client 102 can display multiple images. If the maximum web page size of the client 102 is too small to present multiple images, the optimizer 134 may determine that the web page 138 included in the response to the HTTP request be optimized. Another way that the optimizer 134 may determine whether to optimize the response may be through a look up in a user preferences 139. The user preferences 139 may specify that all web pages 138 included in responses to a particular client 102 be optimized.

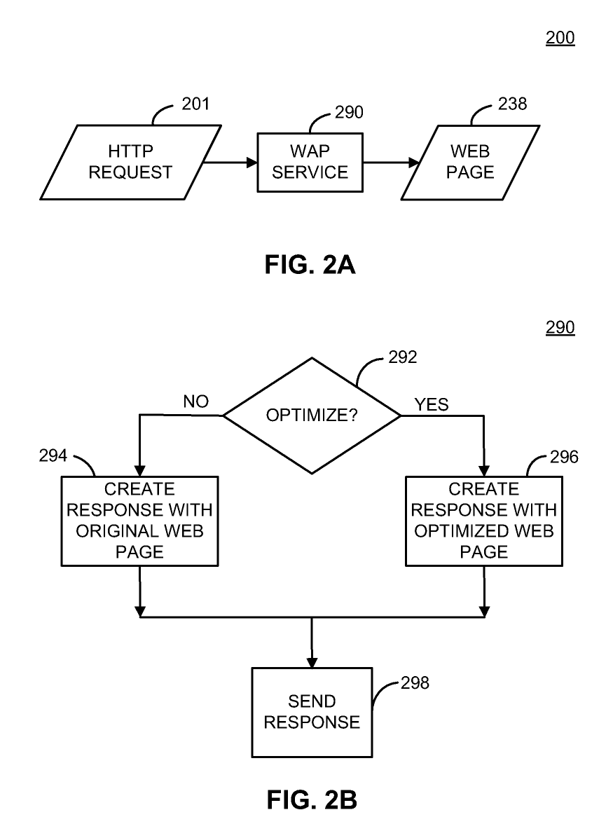

FIG. 2A illustrates a data flow diagram of a method 200 in accordance with one or more implementations of various techniques described herein. The WAP service process 290 may use an HTTP request 201 as an input and may produce an optimized response. The optimized response may include a web page 238 modified for display on the client 102. In one implementation, the process 290 may be performed by the WAP server 136.

FIG. 2B illustrates a flowchart of the process 290 in accordance with one or more implementations of various techniques described herein. As mentioned above, the process 290 may be performed by the WAP server 136. At step 292, the optimizer 134 of the WAP server 136 may determine whether to provide the client 102 with an abbreviated version of the web page 238 in response to the HTTP request 201. If it is determined that the client 102 is not to be provided with an abbreviated version of the web page 238, then the WAP server 136 may simply create the response with the original web page 238 (step 294). On the other hand, if it is determined that the client 102 is to be provided with an abbreviated version of the web page 238, then, at step 296, the optimizer 134 may create the response with the abbreviated version of the web page 238. At step 298, the WAP server 136 may send the response to the client 102. The process 290 will be described in greater detail with reference to FIGS. 3 and 4, respectively.

FIG. 3 illustrates a data flow diagram of the process 290, in accordance with one or more implementations of various techniques described herein. The process 290 begins with an extract identifiers process 302 whereby identifiers for the client 102 and the WAP browser 114 may be extracted from the HTTP request 301. A capabilities process 315 may then determine performance characteristics of the client 102, the WAP browser 114, and the network 160 based on the extracted identifiers. Finally, an optimization process 330 produces a response 325 to the HTTP request. The response 325 may be optimized based on a user preference, or the performance characteristics derived from the identifiers in the HTTP request.

The HTTP request 301 from the client 102 may be used as input to the extract identifiers process 302. In this extract identifiers process 302, a UA string 310 and an IP address 311 may be extracted from the HTTP request 301. The UA string 310 may specify identifiers for the client 102 and the WAP browser 114.

Once the identifiers are extracted, the capabilities process 315 may look up these identifiers in a capabilities database 305 to determine device capabilities 335A of the client 102. Additionally, the capabilities process 315 may use the IP address 311 to determine the carrier network associated with the client and network capabilities 335B associated with the carrier network.

The device capabilities 335A may include performance characteristics for the WAP browser 114 and the client 102. For example, the performance characteristics for the WAP browser 114 may include whether the WAP browser 114 provides support for presenting rich content, or rendering images. The performance characteristics of the client 102 may include a maximum web page size, which may determine whether the client 102 can display multiple images.

The network capabilities 335B may include performance characteristics for the network 160. Performance characteristics for the network 160 may include average network speed and network latency. In one implementation, the capabilities database 305 may include two databases: one database for storing information about the device capabilities 335A, and another database for storing information about the network capabilities 335B. The database that stores information about the network capabilities 335B may be updated dynamically based on response times as users visit the web site.

Once computed, the device capabilities 335A, the network capabilities 335B, the user preferences database 339, and a web page 338 (requested by the client 102) may then be used as input to the optimization process 330. In situations where a user preference is not available, a determination may be made by the optimization process 330 whether to optimize the response 325 based on the device capabilities 335A and the network capabilities 335B. For example, if the device capabilities 335A indicate that the output device 119 of the client 102 is too small to display images, the optimization process 330 may send the response without images. As another example, if the network capabilities 335B indicate that the network latency is high or the average network speed is low, the optimization process 330 may send the response without images regardless of the display size.

In situations where a user preference is available, the optimization process 330 may optimize the response 325 based on a user preference stored in the user preferences database 339. The user preference may specify whether to optimize responses 325 to a particular client 102. Additionally, the user preference may specify that user-generated, or static, content not be removed/replaced in optimized responses. Accordingly, the optimization process 330 may send an optimized response based on the stored user preference. In one implementation, the user preference may be included in the HTTP request, instead of being stored in the user preferences database 339.

FIG. 4 illustrates a flowchart of a method 400 for creating an optimized response in accordance with one or more implementations of various techniques described herein. The method 400 may be part of step 296 described in FIG. 2B, whereby an abbreviated version of the web page 138 is created for the response 325 that is optimized. In one implementation, the method 400 may be performed by the optimizer 134.

The web page 338 requested by the client 102 may include references to numerous objects identified by tags. Typically, the WAP browser 114 reads tags within the web page 338 to determine how the object identified by the tag may be presented to the user. The tag may also identify object types, such as images, text, and the like. In the case of media objects (images, video, etc.), the tag may include a uniform resource locator (URL), that specifies the location of the media object. The URL may identify a local or remote location.

The method 400 may be repeated for each tag within the requested web page 338 that identifies media-type objects, e.g., images. Step 410 is a loop that includes steps 415-445. At step 415, the optimizer 134 may determine whether the object identified by the tag includes a static content URL. The static content URL may identify user-generated content within the web page 338 that is included in the response 325 based on the user preference. If the user preference specifies that user-generated content is not to be removed/replaced in optimized responses, and the object identified by the tag includes a static content URL, at step 445, the object is kept in the web page 338 as original.

If the original object identified does not include a static content URL, the optimizer 134 may determine whether the tag includes an “ALT” attribute (step 420). The “ALT” attribute may specify an alternative object that may be presented to the user in place of the original object. Typically, the alternative object is a text description of the original object. In the case of an image object, the text may describe the image. If the tag includes an ALT attribute, the optimizer 134 may replace the original object with the alternative object in the optimized response (step 425).

If the tag does not include an ALT attribute, the optimizer 134 may determine whether the URL of the original object is included in the configuration 133. If the URL of the original object is not included in the configuration 133, then the optimizer 134 may remove the tag and the original object from the web page 338 included in the response (step 440). However, if the URL of the original object is included in the configuration 133, the optimizer 134 may perform an action based on an action specified in the configuration 133. In one implementation, three possible actions may be specified: “REPLACE,” “REMOVE,” or “KEEP.” If the specified action is “REPLACE,” the configuration 133 may also specify an alternate object with which to replace the original object in the response 325. If so, the process then proceeds to step 425 where the media object is replaced in the response 325 with the alternate object.

If the specified action is “REMOVE,” the process then proceeds to step 440 where the optimizer 134 may remove the tag and the original object from the response 325. On the other hand, if the specified action is “KEEP,” the process then proceeds to step 445, where the original object is included in the response 325 without modification.

After all the media tags have been processed by the optimizer 134, the response 325 may include the web page 338 that has been abbreviated for presentation on the client 102, with resource-intensive objects either removed or replaced by lesser resource-intensive objects like simple text.

The various technologies described herein may be implemented in the general context of computer-executable instructions, such as program modules, being executed by a computer. Generally, program modules include routines, programs, objects, components, data structures, etc. that perform particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for creating a response to a hypertext transfer protocol (HTTP) request from a mobile device comprising:
receiving the HTTP request from the mobile device; and
determining whether to optimize the response based on a user preference for reducing response times to the mobile device; and
if it is determined that the response is to be optimized, then (i) determining an action to be performed on an object in connection with optimizing the response, wherein the object is part of a document specified in the HTTP request; and (ii) generating the optimized response based on the action.

2. The method of claim 1, wherein the user preference is within the HTTP request.

3. The method of claim 1, wherein the response comprises the document.

4. The method of claim 1, wherein the document is a web page.

5. The method of claim 1, wherein the object is one of an image object, a video object, an audio object or combinations thereof.

6. The method of claim 1, wherein the action is performed by a wireless application protocol (WAP) server.

7. The method of claim 1, wherein the action is performed by a server in an i-mode system.

8. The method of claim 1, wherein the action to be determined is based on a configuration file that specifies the action for the object, wherein the action is one of remove or replace.

9. The method of claim 1, wherein the action comprises replacing the object in the response with a substitute object, wherein the substitute object uses fewer resources to be presented on the mobile device than the object.

10. The method of claim 9, further comprising determining whether to replace the object based on the user preference and a uniform resource locator that identifies a location of the object.

11. The method of claim 1, wherein the action comprises removing the object from the response.

12. The method of claim 9, wherein the object is an image and the substitute object is a text description of the image.

13. The method of claim 1, wherein determining whether to optimize the response comprises:
determining one or more device capabilities of the mobile device based on a user-agent string within the HTTP request; and
determining whether to optimize the response based on the device capabilities.

14. The method of claim 1, wherein determining whether to optimize the response comprises:
determining one or more network capabilities of a carrier network associated with the mobile device based on an Internet protocol (IP) address within the HTTP request; and
determining whether to optimize the response based on the network capabilities.

15. A computer system, comprising:
a processor; and
a memory comprising a wireless application protocol (WAP) server executable by the processor to:
receive a hypertext transfer protocol (HTTP) request from a mobile device for a web page;
determine one or more device capabilities of the mobile device based on a user-agent string within the HTTP request;
determine one or more network capabilities of a carrier network associated with the mobile device based on an Internet protocol (IP) address within the HTTP request;
determine whether to optimize the response based on the device capabilities, the network capabilities, and a user preference for reducing response times to the mobile device; and
if it is determined that the response is to be optimized, then (i) determine an action to be performed on an object in connection with optimizing the response, wherein the object is part of the web page; and (ii) generate the optimized response based on the action.

16. The computer system of claim 15, wherein the object is an image, and the WAP server is further executable by the processor to:
perform the action, wherein the action is to replace the object in the response with a substitute object, wherein the substitute object is a text description of the image that uses fewer resources to be presented on the mobile device than the object.

17. The computer system of claim 16, wherein the WAP server is further executable by the processor to determine whether to replace the object based on a uniform resource locator that identifies a location of the object.

18. The computer system of claim 15, wherein the action comprises removing the object from the response.

19. A user interface for setting a response mode on a mobile device, comprising:
displaying a hyperlink that specifies a user preference to reduce a response time to an HTTP request from the mobile device;
receiving a user selection of the hyperlink; and
sending the user preference to a web server for mobile devices.

20. The user interface of claim 19, wherein the web server is a wireless application protocol (WAP) server.
